(19) United States
(12) Patent Application Publication
(10) Pub. No.: US 2002/0020254 A1
(43) Pub. Date: Feb. 21, 2002

(54) Tire plugger

(76) Inventor: Douglas Pittman, Westmont, NJ (US)

Correspondence Address: Woodcock Washburn Kurtz, Mackiewicz & Norris LLP, 46th Floor, One Liberty Place, Philadelphia, PA, 19103, US

(21) Appl. No.: 09/920,312

(22) Filed: Aug. 1, 2001

Related U.S. Application Data
(60) Provisional application No. 60/222,061, filed on Aug. 1, 2000.

(51) Int. Cl. B29C 73/08; B29C 73/00

(52) U.S. Cl. 81/15.7; 152/370; 81/15.2

(57) ABSTRACT

A tire plugging device allows a mechanic to pressurize and plug a tire in one operation. This device could also be used in inflating and repairing tires that have multiple chambers that are factory inflated and sealed.

### FIELD OF THE INVENTION

The present invention relates generally to the field of inflating pneumatic tires.

### SUMMARY OF THE INVENTION

The present invention, which is described in detail below, is designed to replace current pneumatic tire plugging devices with a device that allows simultaneous inflation and sealing of a pneumatic tire.

### BRIEF DESCRIPTION OF THE DRAWINGS

FIGS. 1 and 2 schematically illustrate one presently preferred embodiment of the invention.

FIGS. 3A and 3B illustrate an exemplary holder for the inventive device, and FIGS. 4-7 illustrate use of the device to inflate a tire (only a wall of the tire is shown).

### DETAILED DESCRIPTION OF THE PREFERRED EMBODIMENTS

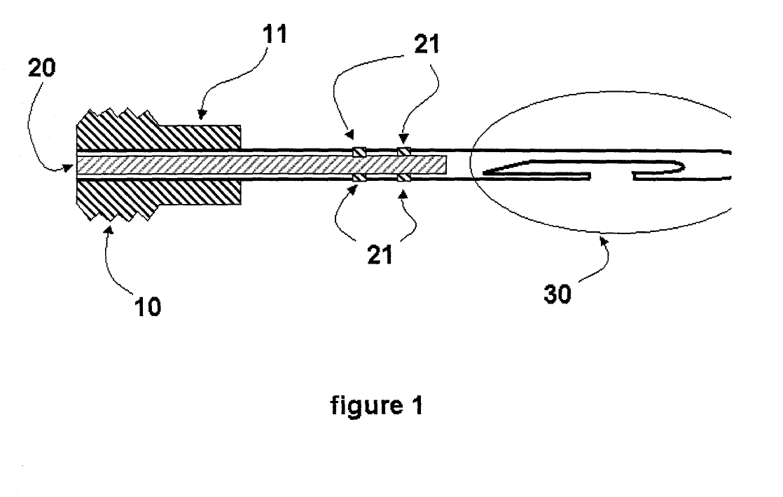

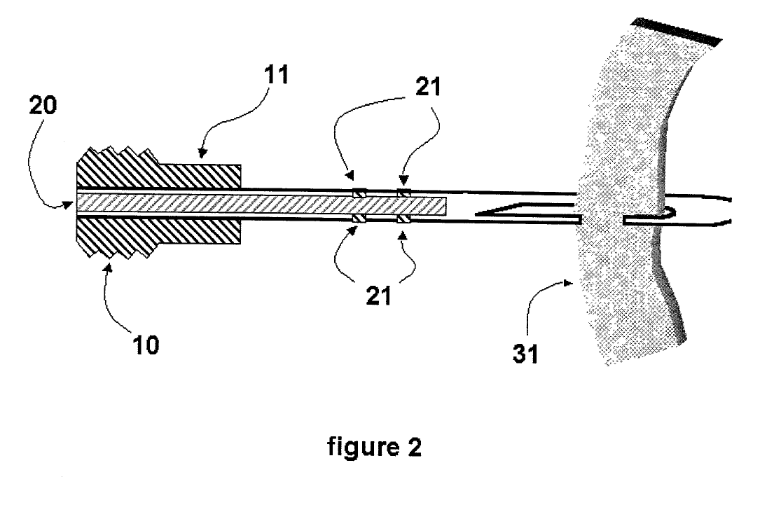

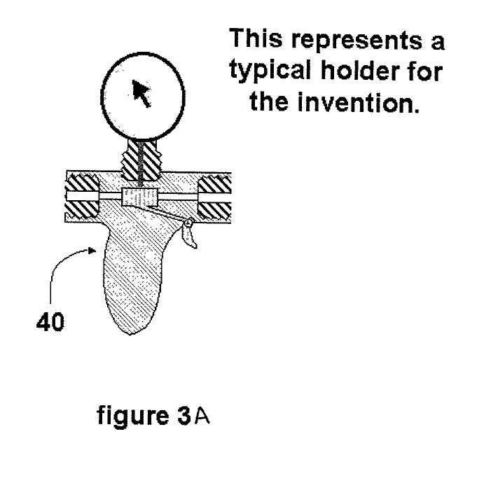

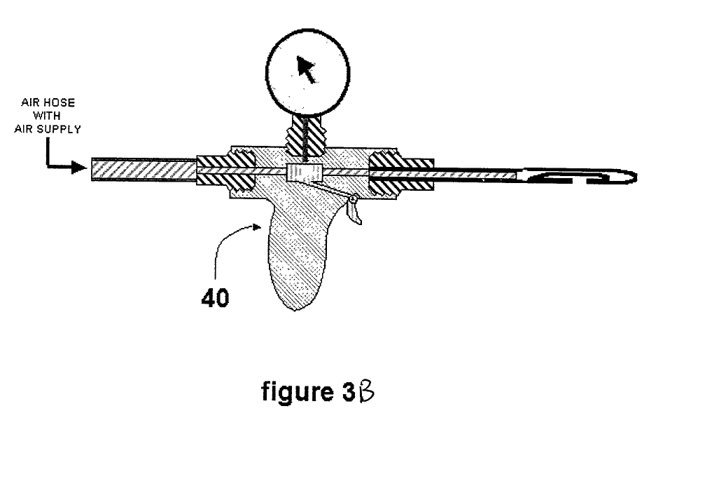

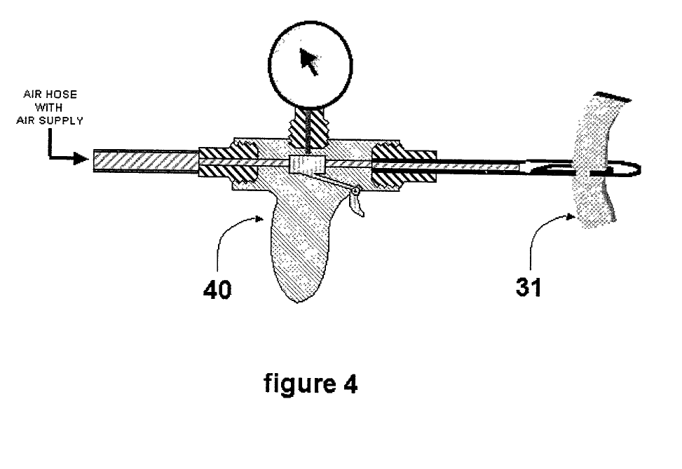

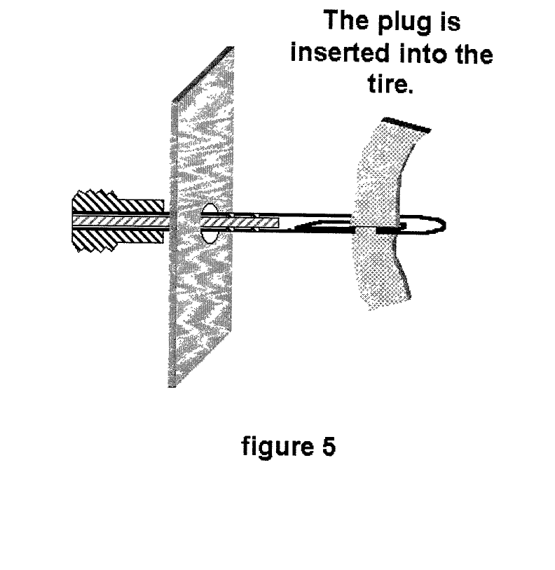

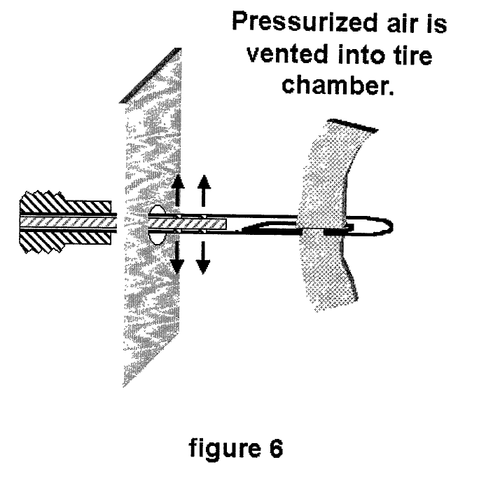

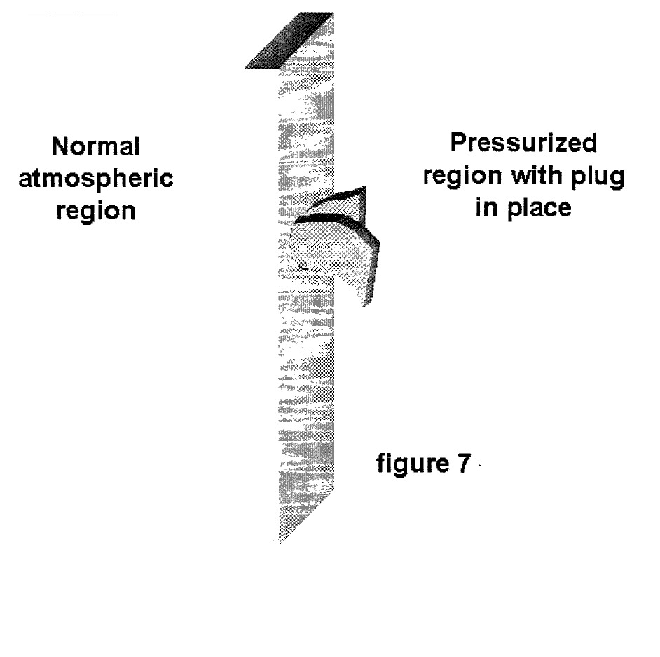

Referring to FIG. 1, the presently preferred embodiment is shown as a sectional view. Threaded section 10 is screwed into existing hand controlled, lever actuated, compressed air tools. The tire plugging device is tightened using existing adjustable wrenches that fit across standard hexagonal flats of 11. After the device is attached to the aforementioned hand operated compressed air dispenser, a tire mechanic then places a standard tire plug into existing prior art 30 as shown in FIG. 2. The tire mechanic then inserts the tire plug into the tire covering up vent holes 21. The tire mechanic then fills the tire with compressed air to the maximum preset value from his air compressor. When the preset air pressure has been met, the tire mechanic withdraws the device but with leaving the tire plug installed within the tire wall.

This device could also be used in inflating and repairing tires that have multiple chambers that are factory inflated and sealed. Other embodiments of the present invention are also with the scope of protection of the following claims.

I claim:

1. A tire plugging device with a hollow core that can fill transportation tires.

2. A tire plugging device as recited in claim 1, with vents strategically placed in a main shaft of the device so that when a tire plug is inserted into a tire, the vent holes are within the interior of the tire.

3. A tire plugging device as recited in claim 1 for use in plugging multicellular sealed chambered tires.
